(19) United States
(12) Patent Application Publication
(10) Pub. No.: US 2006/0235873 A1
(43) Pub. Date: Oct. 19, 2006

(54) SOCIAL NETWORK-BASED INTERNET SEARCH ENGINE

(75) Inventor: Kapenda J. Thomas, Bellevue, WA (US)

Correspondence Address: BLACK LOWE & GRAHAM, PLLC, 701 FIFTH AVENUE, SUITE 4800, SEATTLE, WA, 98104, US

(73) Assignee: Jookster Networks, Inc., Seattle, WA (US)

(21) Appl. No.: 11/425,635

(22) Filed: Jun. 21, 2006

Related U.S. Application Data
(63) Continuation-in-part of application No. 10/783,575, filed on Feb. 20, 2004.
(60) Provisional application No. 60/692,658, filed on Jun. 21, 2005.
(60) Provisional application No. 60/692,659, filed on Jun. 21, 2005.
(60) Provisional application No. 60/513,852, filed on Oct. 22, 2003.
(60) Provisional application No. 60/538,515, filed on Jan. 23, 2004.

(51) Int. Cl. G06F 7/00

(52) U.S. Cl. 707/102

(57) ABSTRACT

Filtering Internet content includes receiving a search query message comprising a search query to an Internet search engine. Data is received from the Internet search engine, responsive to the search query message. Filtering of the data produces a data subset. The filter selects data for inclusion in the data subset based upon occurrence of the data in a database. The database includes content selected for inclusion by designated users. The data subset is displayed in a browser.

### PRIORITY CLAIM

This application claims priority from the provisional application entitled A METHOD AND APPARATUS. FOR COLLABORATIVE SEARCHING with Ser. No. 60/692,658 filed on Jun. 21, 2005 and from the provisional application entitled METHOD AND APPARATUS FOR IDENTIFYING A URL FOR SUBMITTAL TO A COLLABORATIVE SEARCH ENGINE with Ser. No. 60/692,659 filed on Jun. 21, 2005. Both provisional applications are incorporated by this reference.

This application is a continuation in part of U.S. patent application Ser. No. 10/783,575, filed on Feb. 20, 2004, which is hereby incorporated by reference which in turn claims priority from the provisional application entitled TRUSTED FRIEND BASED INTERNET SEARCH ENGINE with Ser. No. 60/513,852 filed on Oct. 22, 2003 and from the provisional application entitled SOCIAL NETWORK-BASED INTERNET SEARCHING with Ser. No. 60/538,515 filed on Jan. 23, 2004. Both provisional applications are incorporated by this reference.

### FIELD OF THE INVENTION

This invention relates generally to Internet search engines and, more specifically, to social network-based Internet search engines.

### BACKGROUND OF THE INVENTION

Currently the Worldwide Web (all the resources and users on the Internet that are using the Hypertext Transfer Protocol) contains registration for over 3 billion URLs. The amount of Internet content continues to grow rapidly and to outpace the ability of search engines to index the exploding amount of information. The largest search engines cannot keep up with the growth as it has been estimated that search engines only index about 5% to 30% of the information content on the Web. Hence, at the current time, the majority of Web content is not classified or indexed by any search engine.

To make information accessible to the searcher, providers accumulate directories of information that is indexed and therefore searchable. One approach has been the use of Web Directories; content editors to manually categorize and recommend sites to build LDAP directories. Relying upon human editors to manually go through and survey sites on the Web is slow and expensive for the provider and is inherently more expensive at the expanding rate at which the Internet grows.

Recently, the traditional Web client-server paradigm has been challenged by distributed file-sharing systems that support a peer-to-peer model for exchanging data. In peer-to-peer networks, each computer platform, or node, can operate as a hub, i.e., each node has both client functionality and server functionality. Each node has a list of addresses, most commonly Internet Protocol (IP) addresses, of several other nodes, or “peer nodes”. These nodes can directly communicate with each other without a central or intermediate server.

Nodes within a peer-to-peer network form a distributed file-sharing system in which the nodes act cooperatively to form a distributed search engine. When a user at a node enters a search query, the search query is copied and sent to its list of peer nodes. Each peer node searches its own databases in an attempt to satisfy the search query. Each node copies the query to each node in its list of peer nodes while observing a time-to-live value in the query message. If a resulting query hit is made, then the node returns some type of query results to the originating node. The search quickly fans out amongst a large number of nodes, which provides a useful manner for finding new content that has not yet been indexed by the large search engines.

In addition to remaining up to date, an effective search engine must rank information. The changing nature of the information stored on the Worldwide Web drives the need for not merely locating information but also for winnowing the information to limit the returned information to such that is relevant to the user. It would be advantageous to sort information according to a criterion that will conform with the interests of the user. Because so many users do access the Web, it would be advantageous to sort information according to the recommendation of other users of the Web. Further advantages accrue if the other users of the Web are within the interest groups or buddy lists selected and defined by current user.

Since the Web is a dynamic environment where content is constantly being added, updated, and changed, it is very difficult for the search engines to be and to remain up-to-date. Therefore, it would be advantageous to provide a method and system for augmenting traditional searches of Internet-based content. It would be particularly advantageous to use aspects of peer-to-peer networks to assist in obtaining relevant search results.

### SUMMARY OF THE INVENTION

Filtering Internet content includes receiving a search query message comprising a search query to an Internet search engine. Data is received from the Internet search engine, responsive to the search query message. Filtering of the data produces a data subset. The filter selects data for inclusion in the data subset based upon occurrence of the data in a database. The database includes content selected for inclusion by designated users. The data subset is displayed in a browser.

In accordance with still further aspects of the invention, based upon accessing the user's Web filters as well as the Web filters of other selected users, the present invention includes the functionality to persist, search and retrieve views of information. Formulating algorithms to reflect an individual's own preferences entails a lengthy training period requiring numerous individual selections. The present invention, rather, leverages the Web experiences of a number of individuals that the user selects as reflective of the user's own preferences. The collective experience of a whole social network of the number of individuals more rapidly populates a filter or set of filter to build a greater likelihood of locating information that will satisfy a user's needs according to their preferences. Additionally, the user can use the invention to save and to manipulate views and to add or remove individuals from the number of individuals.

In accordance with yet other aspects of the invention, the invention also provides an ability to push an advertisement from a third party advertiser. By means of information garnered from the recurrent searches by the number of individuals making up a social network, the advertiser can target only advertising consistent with the desires of the individuals as expressed in their regular searching activities. Each view saved in association with one or more of the individuals in the social network has multiple associated categories based upon the URL's saved within a specific view. By using the category information an advertiser can be specifically target a user or groups of users within a social network, or a defined subset of that network. The targeting function can be further enhanced by the roles that the user selects to identify the user (i.e.: Runner, Attorney, Children, Teen, etc) thereby revealing demographic information. Where users in the social network do react in a trackable means to the advertisement, the reactions can be associated with the individuals in the social network to provide further indication as to the match between the advertisement and the social network.

In accordance with still another aspect of the invention, the invention provides the user the ability to recommend a site to a friend or colleague while perusing a site in real-time. The recommendation engine will send an introduction email to the user along with a site recommendation to enable the potential new user to become social network member. The recommendation engine will provide the ability to track recommendations.

As will be readily appreciated from the foregoing summary, the invention provides an integrated enhancement to an Internet search engine that is both platform-independent and will work with one or several search engines. The results, in fact, are enhanced if the individuals in the social network do use diverse distinct search engines.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A is a block diagram that depicts a simplified, Internet-based connection between two computers;

FIG. 2B is a block diagram that depicts software components within two computers that are operating as nodes within a peer-to-peer network;

FIG. 2C is a block diagram depicting typical software subcomponents within a peer-to-peer software component that contains file sharing functionality;

FIG. 2D is a block diagram depicting a typical network topology of nodes within a peer-to-peer network;

FIG. 3 depicts a typical, Web-based, indexing-type, search engine;

FIG. 4 depicts a database chart depicting an example of a social network searching filter;

FIG. 5A is a network topology depicting an example of a client-server graphical embodiment of a social network searching filter;

FIG. 5B is a network topology depicting an example of a serverless peer-to-peer graphical embodiment of a social network searching filter;

FIG. 5C is a network topology depicting an example of a server-steered peer-to-peer graphical embodiment of a social network searching filter;

FIG. 5D is a network topology depicting an example of an extended server-steered peer-to-peer graphical embodiment of a social network searching filter;

FIG. 6A is a diagram showing a set of URLs within the HTML source code of a search result that has been generated in accordance with a preferred embodiment of the present invention;

FIG. 6B is a diagram showing a set of URLs within the HTML source code of a search result that has been generated in accordance with a preferred embodiment of the present invention;

FIG. 7A is a diagram depicting an example of a dialogue box used to augment a defined group of users;

FIG. 7B is a diagram depicting an example of a dialogue box used to recommend a website to a defined group of users;

FIG. 8 is a flowchart depicting an overall process for providing an augmented search in accordance with the present invention;

FIG. 9 is a diagram depicting an example user interface in accordance with an embodiment of the invention;

FIG. 10 is a flowchart depicting an example process of indexing resources of a new user in accordance with an embodiment of the invention;

FIG. 11 is a flowchart depicting an example process of adding a new user to an existing network in accordance with an embodiment of the invention;

FIG. 12 is a diagram depicting an example user interface used to indicate a resource is of interest in accordance with an embodiment of the invention;

FIG. 13 is a flowchart depicting an example process of indexing a resource in accordance with an embodiment of the invention;

FIG. 14 is a diagram depicting an example of a portion of an indexing architecture in accordance with an embodiment of the invention;

FIG. 15 is a diagram depicting an example of a search results format in accordance with an embodiment of the invention;

FIG. 16 is a flowchart depicting building an indexed database; and

FIG. 17 is a flowchart depicting ranking of resources within a database.

### DETAILED DESCRIPTION OF THE PREFERRED EMBODIMENT

By way of overview, filtering Internet content includes receiving a search query message comprising a search query to an Internet search engine. Data is received from the Internet search engine, responsive to the search query message. Filtering of the data produces a data subset. The filter selects data for inclusion in the data subset based upon occurrence of the data in a database. The database includes content selected for inclusion by designated users. The data subset is displayed in a browser.

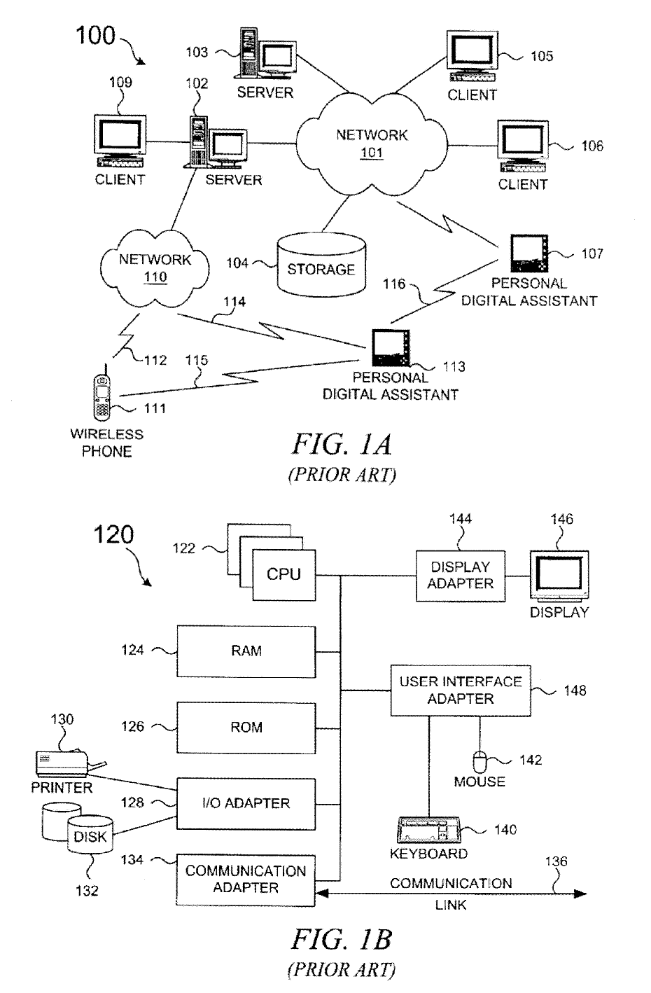

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 117 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to providing a method and system for accessing information on a network that includes peer-to-peer networks or subnets. As background, a typical organization of software components within a peer-to-peer network is described before describing the present invention in more detail.

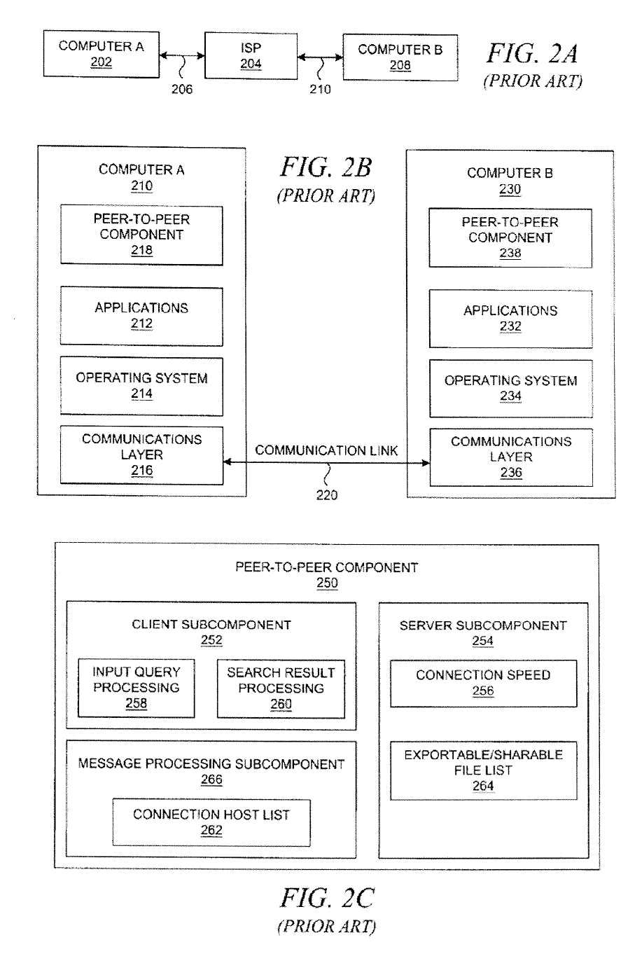

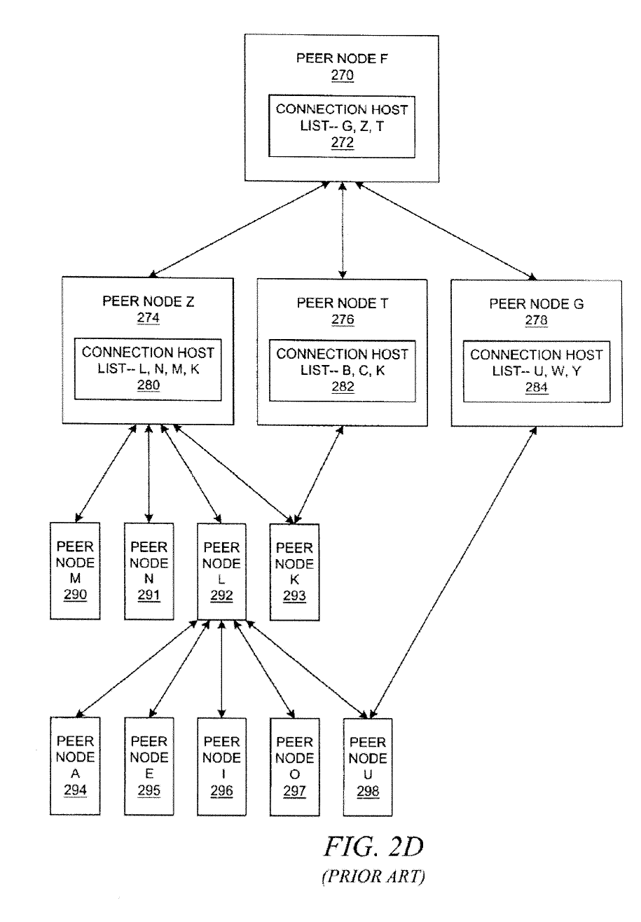

While the invention may be used in a server to client relationship, the more complex peer-to-peer embodiment better describes the features and embodiment of the invention. To describe the peer-to-peer environment, some background is necessary. With reference now to FIG. 2A, a block diagram depicts a simplified, Internet-based connection between two computers. Computer 202 communicates with ISP (Internet Service Provider) 204 across communication link 206, and computer 208 communicates with ISP 204 across communication link 210. Users of computers 202 and 208 can employ browsers and other networked applications, such as a peer-to-peer file sharing application, to send and receive information across a network, which includes the Internet in this example. Those of ordinary skill in the art will recognize that Internet-based connections between nodes 204 and 208 also may be achieved without using an ISP. For example, a Local Area Network or corporate intranet may be used. The use of an ISP is not intended to be an architectural limitation of the present invention.

With reference now to FIG. 2B, a block diagram depicts software components within two computers that are operating as nodes within a peer-to-peer network. Computer 210 has network-enabled applications 212 that use operating system 214 for various services, such as network communication services provided by communications layer 216. In addition, peer-to-peer component 218 may be a stand-alone applet or an application that provides peer-to-peer networking functionality to computer 210. Communication link 220 supports data traffic between computer 210 and computer 230, which has software components that correspond to those shown in computer 210: applications 232, operating system 234, communications layer 236, and peer-to-peer component 238. Peer-to-peer components 218 and 238 may provide support for a distributed, peer-to-peer file sharing function, as shown in more detail in FIG. 2C.

With reference now to FIG. 2C, a block diagram depicts typical software subcomponents within a peer-to-peer software component that contains file-sharing functionality. As noted previously, in peer-to-peer networks, each computer platform, or node, can operate as a hub, i.e., each node has both client functionality and server functionality. Peer-to-peer component 250 contains client subcomponent 252 and server subcomponent 254.

The method by which nodes in a peer-to-peer network connect with each other may vary with the type of peer-to-peer network. Generally, a client is dynamically assigned an IP address by an ISP when the client connects to the ISP, so the IP address possibly changes with each client session. In some implementations, a peer-to-peer connection between nodes in a peer-to-peer network is initiated when a user at a node manually enters either a domain name or an IP address (and optionally a port number) of an application of another node that is known to support peer-to-peer networking. The peer-to-peer application then establishes a connection with the other node at the specified address as a starting point within the network.

For example, applications using the Gnutella protocol operate in this manner. Gnutella nodes also exchange connection speed, such as connection speed 256, that describe the speed of the network connection that is being used by the node. It should be noted, however, that the present invention can be implemented on a variety of peer-to-peer networks and is not limited by the peer-to-peer protocol that is used by the file sharing applications.

Nodes within a peer-to-peer network can act as a distributed file sharing system in which the nodes act cooperatively to form a distributed search engine. Client subcomponent 252 contains input query processing function 258 and search result processing function 260. When a user at a node enters a search query, the search query is copied to a list of peer nodes to which the node is connected, such as connection host list 262.

When a node receives the query, its server component, such as server component 254, processes the query. Each peer node searches its own databases in an attempt to satisfy the search query. Alternatively, a user has previously specified a list of files that the user is willing to export or share, such as file list 264, and the server subcomponent searches this list to find one or more files that satisfy the search query. Alternatively, rather than searching through a list of file names, the application may search the node's permanent storage for content that matches the search query. Depending on certain parameters within the query message, the node also forwards the query, e.g., by using message processing subcomponent 266, to each node in its list of connected peer nodes. If a resulting query hit is made, then the node returns some form of query results to the peer node that contacted it or to the originating node. In this manner, the search quickly fans out amongst a large number of nodes.

With reference now to FIG. 2D, a block diagram depicts a typical network topology of nodes within a peer-to-peer network. Peer node 270 has a connection host list 272 that identifies nodes 274-278 to which peer node 270 is connected, and nodes 274-278 have their own connection host lists 280-284, respectively. In this example, node 274 connects to nodes 290-293, and node 292 connects with nodes 294-298.

It should be noted that peer-to-peer networks do not have a structured topology, such as a strictly hierarchical organization amongst the nodes. For this reason, no single server is depicted, though the invention will appropriately function in a server-client relationship. In the peer-to-peer example, node 276 also connects with node 293, and node 278 also connects with node 298. However, in order to distinguish immediately connected nodes from distant nodes, the set of nodes to which a particular node connects may be termed the “root nodes” of the particular node.

As noted above, the present invention is not limited to any particular peer-to-peer protocol that is used to implement the present invention. As background information, though, the Gnutella protocol is described in more detail as an example of the manner in which information may be passed in a peer-to-peer network between nodes that support a file sharing application. Reference may be made to the above description for FIG. 2C and FIG. 2D for components that would support file sharing within a peer-to-peer network using a protocol similar to Gnutella.

Gnutella is an Internet-based file searching/sharing program that combines both search engine functionality and file server functionality in a single application. When a user enters a search term into a Gnutella-enabled application at a node in the peer-to-peer network, a query message is generated with the appropriately formatted information, and the message is sent as a network packet to the user node's connected peers, i.e., peer nodes with which the user's node has already established a connection or session. Special codes within a Gnutella message header indicate the type of message, and each type of message has a unique code.

Any node within a certain distance from the user's node in the peer-to-peer network, i.e., within a certain node “hop count”, will receive the query message; there is no mechanism to kill a query. As a query message moves through the connected nodes, a time-to-live (TTL) data field, which represents the hop count, is decremented. If the TTL field reaches zero, then the receiving node should not forward the query message, i.e., it should “drop the packet”. Otherwise, the receiving node forwards the query message.

Each message contains a Globally Unique Identifier (GUID). When a new message is generated, a new GUID is also generated and placed within the new message. The manner in which the GUID is generated is not specifically specified by the Gnutella standard. When any message is received, the GUID is compared to a list of GUIDs, each of which were stored when its corresponding message was received. If the GUID is in the list, this fact indicates that the receiving node has seen this particular message previously because the GUIDs are supposed to be unique. Hence, if the GUID is in the list, then the node should not forward the received message because the receiving node's peer nodes would have also seen the message, and the packet can be dropped.

In addition, if the receiving node can fulfill the query, then the node creates a query hit (query reply) message and returns it to the node that originated the query message. The query-hit message contains the address and port number of the responding node so that the originating node can send a message back to the responding node to retrieve a file if desired. The query-hit message also contains the connection speed of the responding node and the number of search hits. For each query hit, the query hit message also contains the name of the file that satisfies the query and the size of that file. Other information may be included, such as length of the data content within the message, etc.

If the originating node has sufficient communication bandwidth, the results of the search should be received within a relatively short amount of time. The search results are stored or cached as they are received. The Gnutella-enabled application then presents the search results to the user in some fashion, and the user may select, through some type of user interface in the application, a filename that the user desires to retrieve. The application, which has stored the search results that include one or more nodes that responded with a search hit, can download a selected file to the user's node. Simple HTTP messages can be used for the download operation, such as a “Get” or a “Put” message (for a Gnutella “Push” request).

The Gnutella protocol operates without a central server. Unlike typical search engines, Gnutella searches anonymously, and there is no index. There is also no authentication process nor authorization process. There are other types of messages within the Gnutella protocol, such as “Ping” and “Pong”, for discovering other nodes on the network and for responding to “Ping” messages. Additionally, a “Push” request message allows a node within the network but behind a firewall to be contacted to push a file to the outside of the firewall rather than attempting to pull the file from inside the firewall. It should be noted that the Gnutella protocol specification is an open specification and is subject to modification and fragmentation over time.

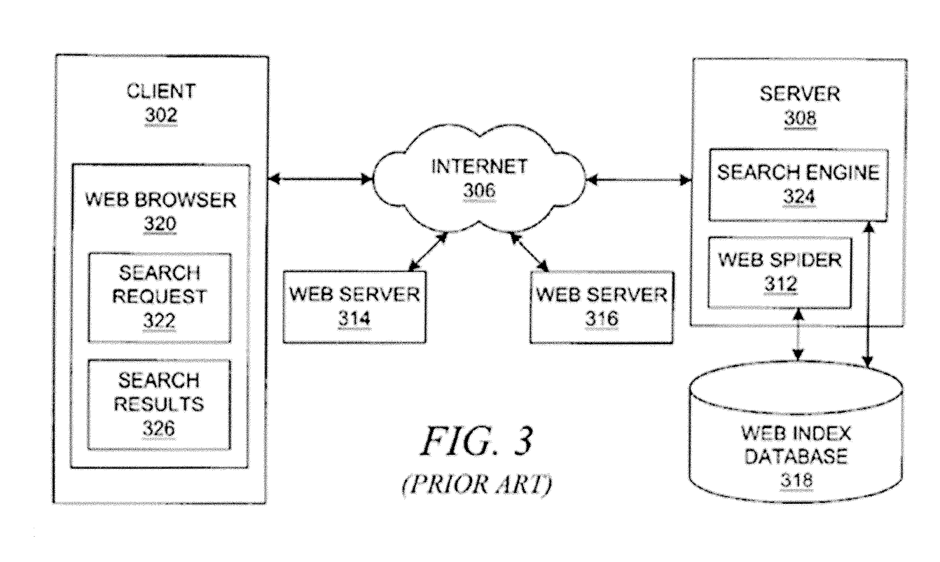

With reference now to FIG. 3, a typical, Web-based, indexing-type, search engine is depicted. Client 302 connects via communication link 304 to the Internet 306, and server 308 connects via communication link 310 to the Internet 306. Server 308 supports Web spider 312, which “crawls” the World Wide Web by following hyperlinks within Web pages or some other means in order to retrieve Web pages and other content from servers 314 and 316. The data gathered by the Web crawler is then indexed and stored within Web index database 318. Certain Web portals perform the indexing process continually.

At some point in time, a user at client 302 may desire to perform a search for specific content on the Web. The user operates Web browser application 320, or some other type of Internet-enabled or Web-enabled application, to retrieve a Web page from server 308 containing a search form for entering a search request or query 322. The user enters a search string, and the search request is sent to search engine 324 on server 308 in an appropriate format, such an HTTP message. The search engine searches through the previously generated index for content that satisfies the user query. If a query-hit is generated, then the search results are returned to client 302, and the browser application displays the results for the user. The user may view the list of results and may determine whether to view the entire contents for an item prior to downloaded the item. In general, the search process is free, but various portals make a profit by selling advertising on their Web site.

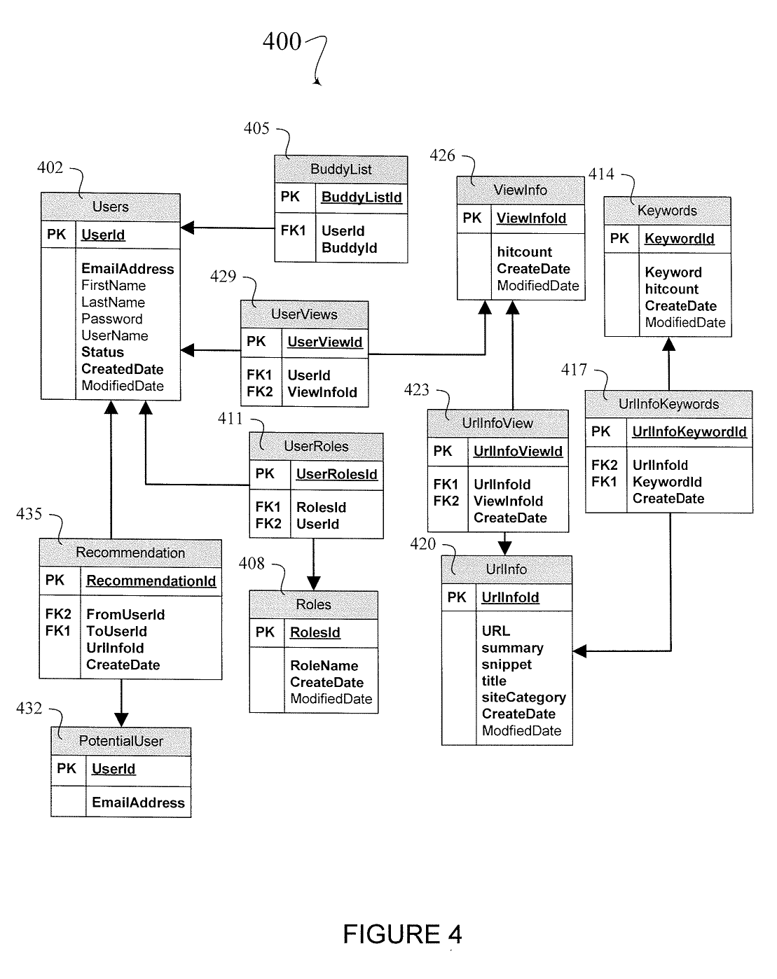

With reference now to FIG. 4, a data flow chart depicts a database structure 400 to enable a presently preferred embodiment of the invention. A unique UserID object 402 is generated to appropriately identify the user and to create appropriate relational blanks within the database. Optionally, a flatfile invoked by the UserID object 402 may advantageously contain the user's e-mail address, first name, last name, a password, a system username, a subscriber status, a created data (a date the user subscribes to the system), and any modified date (a date when the last change to the optional information has been made) may be stored in association with the unique UserID object 402. The unique UserID object 402 allows the invention to relate the user with such unique attributes as to facilitate a user-based social network.

Generally, a second user will be introduced to the invention by referral from a first user. The first user will develop a social network or BuddyList object 405 of second users to help the first user to refine the first user's searching by incorporating the second users' search experience. Thus, the first user accumulates associations with trusted second users to form the BuddyList object 405.

By means out of an association, a BuddyList object 405 is constructed. The BuddyList object 405 defines the social network the user draws upon to refine the user's act of searching the Internet. In a presently preferred embodiment, the BuddyList object is a reflexive relationship, i.e. a BuddyList object 405 is a “colony” of UserID objects 402 linked by elective inclusion. Alternately, the BuddyList object 405 may be unique for each user, such that while a user “A” may include a user “B” in user “A's” BuddyList object 405, that inclusion is not sufficient to cause user “A” to be included in user “B's” BuddyList object 405.

A UserRole object 411, optionally, allows the user to associate the user with various roles that the user fills in living the user's life. A roles database 408 is provided to allow the user to identify the user in this regard. This roles database 408 may be populated by any suitable means but may be predefined or may grow through interaction with the user and with other users. For instance, the roles database 408 may include “Rotarian”, “lawyer”, “hockey player”, “father”, “husband”, “oarsman” and “skier”. These roles are offered to define a demographic classification for the user. While not necessary for the practice of the invention, the roles selected by the user give the opportunity to refine further both the user's interaction with the invention and the interaction of users contained in the users by the list 405. The last, in the presently preferred embodiment, the user, by means of the UserRole object 411. The UserRole object 411 is a constellation of roles the user selects from the roles database 408 and associated with the UserRole object 411.

Having established such identifying associations as the UserRole object 411 and the BuddyList object 405 as the user affirmatively selects, the user now operates the invention. For the purposes of explanation of the process, it is useful to examine interactions between a first user in the course of a first Internet search to populate a keywords database 414 for each user. In a first search, the first user posits a search with a search engine. As set forth with reference to FIG. 3, the user posits the search by constructing a search string, i.e. a series of keywords, and the search string is sent to search engine 324 on server 308 in an appropriate format, such an HTTP message.

The invention develops URLInfoKeyWords object 417 by noting the actions of the search engine in a response to sent keywords. The keywords and the response of the engine to the keywords are recorded, the keywords in the URLInfoKeyWords object 417 and the response in URLInfo object 420. The string of keywords stored in the URLInfoKeyWords object 417 comprises a number of individual keywords drawn from a keyword object 414 and is associated with the URLInfoKeyWords object 417 in a many-to-one relationship. The response by the search engine to the string of keywords, is a series of URL addresses and the series is stored at a URLInfo object 417 in association with the URLInfoKeyWords file 420 that generated the response.

Optionally, the URLInfoKeyWords object 420 may also contain other attributes of the information contained at the URL address. For instance, along with the associated URL address, there may advantageously be stored in the URLInfoKeyWords object 420, a summary attribute of the information stored at the URL address. Similarly, a snippet attribute of the content found at the URL address containing some of the keywords that generated the response might also be advantageously stored in the URLInfoKeyWords object 420. A title attribute also be advantageously stored in the URLInfoKeyWords object 420.

In the most comprehensive embodiment of the invention, it is advantageous to save a view information object in an URLInfoView object 423 in an association with the results of the search. While the URLInfoKeyWords object 420 is a compendium of attributes for one of the addresses returned in the search, URLInfoView object 423 is a listing of the several URLInfoKeyWords objects 420 that make up the response such that the relationship 419 between the URLInfoView object 423 and the URLInfoKeyWords objects 420 is, again, many-to-one. Additionally, it is advantageous to include a date on which the result was delivered by the search engine, thereby taking into account the dynamic nature of the Internet.

A view of the results is created when the user selects various of the results presented and recorded in the URLInfoView object 423 thereby narrowing the search by gleaning only those results the user found useful. In the presently preferred embodiment, the user actively checks those results the user found useful and saves the view in the ViewInfo object 426 and then associates the ViewInfo object 426 with the UserID object 402 in a UserViews Object 429. The URLInfoView object 423 and differs from the results in the ViewInfo object 426 in that the ViewInfo object 426 only stores the results from the URLInfoView object 423 that the user found useful. The ViewInfo object 426 is, in turn associated with the user in the UserViews object 429.

An additional optional function of the invention is the recommendation engine. The recommendation engine gives the user the ability to recommend a site to a friend or colleague while perusing a site in real-time. Tied up with the idea of viral marketing, the recommendation engine works in conjunction with email services allowing a user to forward content found at a URL in an email and send it off to their friends or colleagues with a one-step process to right click. A context menu will appear with an option “Recommend This!”

In a preferred embodiment, a PotentialUser object 432 may well be contained in a “phonebook” or other email directory maintained by the user and containing email addresses. Alternatively, the user may create the PotentialUser object 432 on an “as needed” basis. A RecommendationID object 435 is created to associate the PotentialUser 435 object with the content at the URL and the UserID.

While the preferred embodiment of the database 400, has been presented for purposes of illustration, the invention can be practiced with far fewer objects. For example, with ViewInfo objects 426 associated directly with UserID objects 402, a lookup table would return the results that the user found most useful to the user when submitting that keyword string. Further granularity, as set forth in the preferred embodiment of the database 400 enhances the operation but is not necessary to practice the invention.

The invention may be practice in a number of distinct environments. In a strictly hierarchical environment, i.e. client and server environment, or in several peer-to-peer configurations, the selection of Web content based upon a social network is readily facilitated.

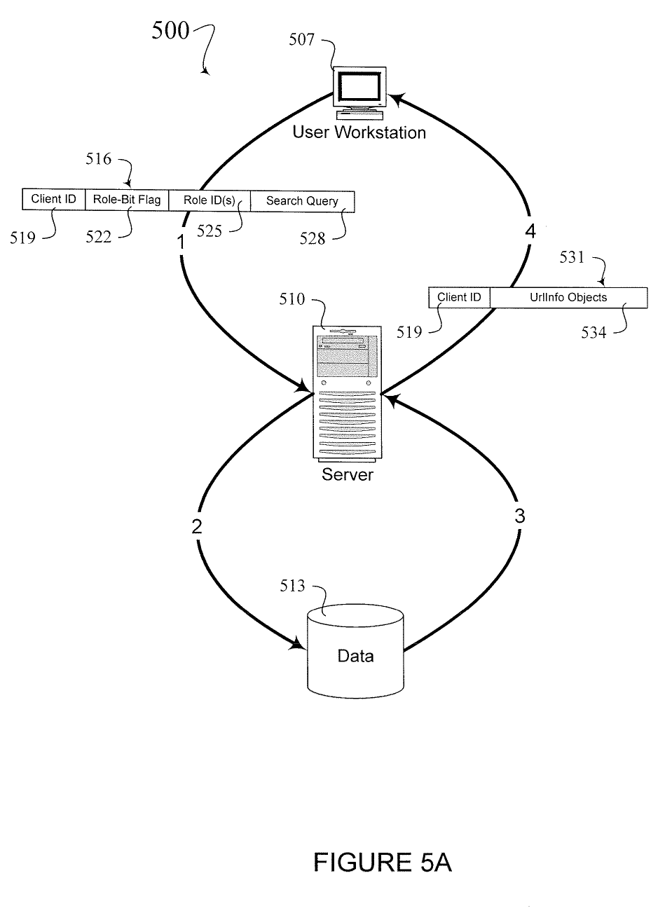

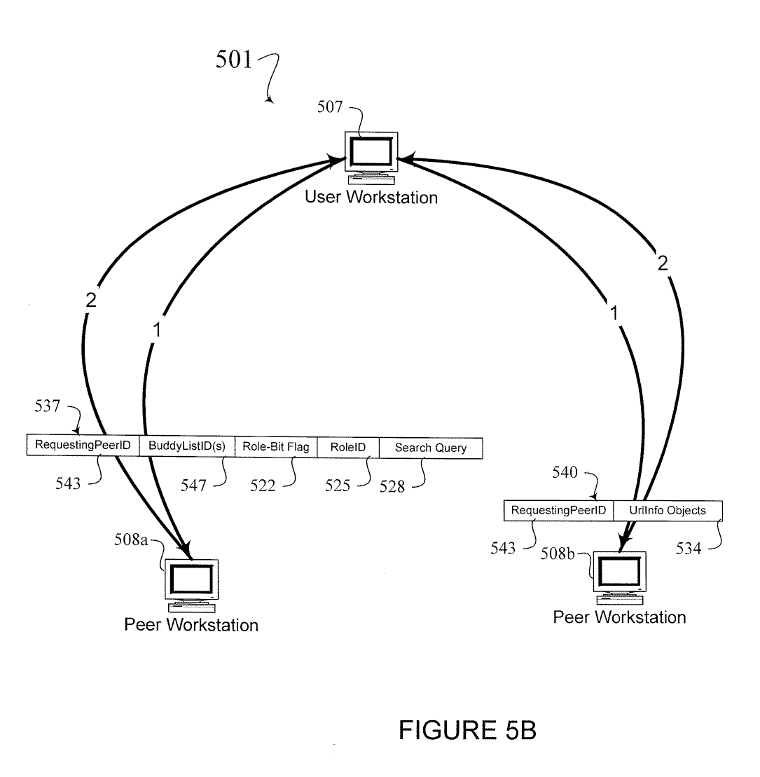

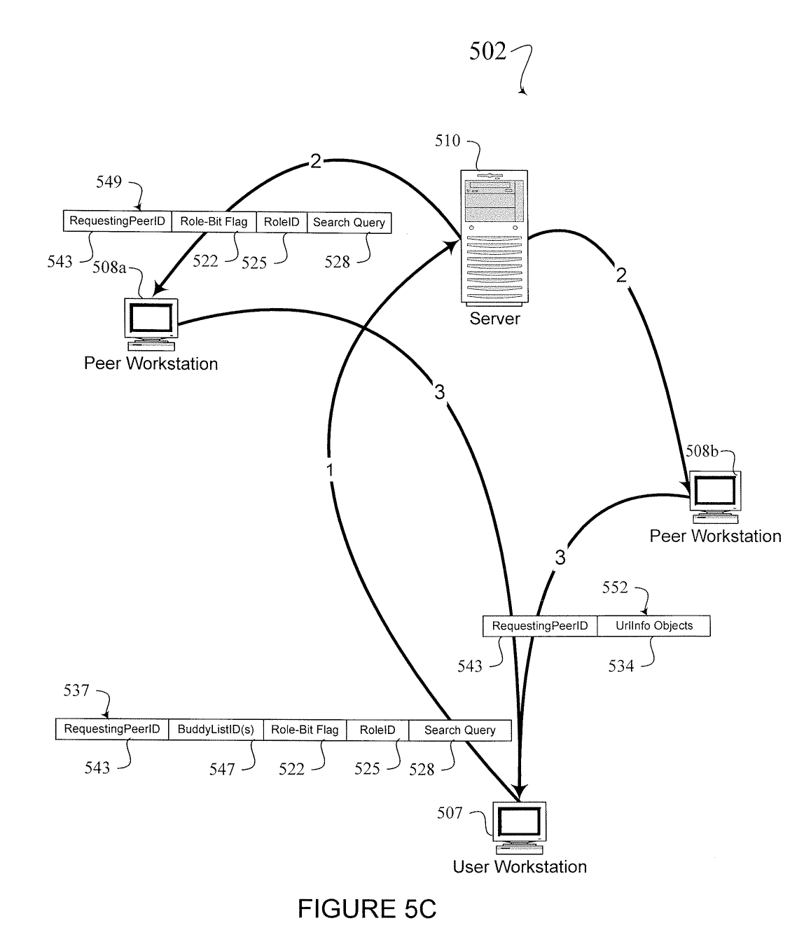

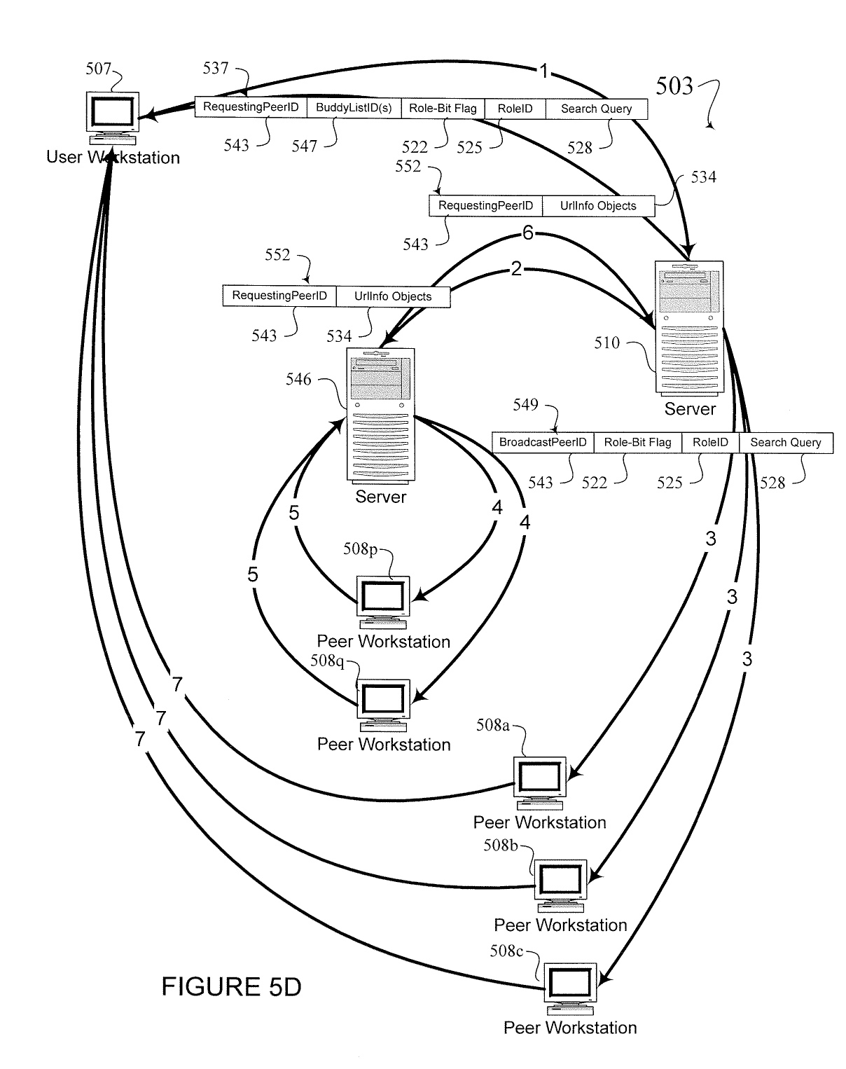

Referring to FIG. 5A, a block diagram of a hierarchical environment is depicted. A user workstation 507 sends a request to the server 510 adhering to a formatted request 516. In a presently preferred embodiment, the formatted request 516 includes a client ID 519, a role-bit flag 522, a role ID 525, and a search query 528.

In this embodiment, the role-bit flag 522 indicates if the search is role-based. A role-based search is a search wherein the user seeks to exploit a specific role associated with the user in order to locate role-specific or role-relevant information in a search of the Internet. By electing to search as one role or another, the user will select a subset of the BuddyList object for winnowing the search results by comparison with successful searches by users in the subset.

At the user's direction, the workstation 507 sends the formatted request 516 to the server 510. In one presently preferred embodiment, the user's workstation 507 simultaneously sends a search query 528 to a search engine by means of an Internet connection. Upon receipt of the formatted request 516, the server compares the search query 528 against search queries stored in the database 513. Where a search query 528 matches or corresponds to a search query stored in the database 513, associated search results 534 stored in the database 513 are returned to the server 510. Once the results are returned to the server 510, the server 510 formats a response 531 for transmission to the user's workstation 507. In a presently preferred embodiment, the response 531 includes the UserID 519, as in the formatted request 519, and the search results 534.

Where the search query 528 was sent to the search engine, the user's workstation optionally filters or orders the response of the search engine according to the search results 534 from the server, displaying the filtered response. If the search query 528 was not sent to the search engine, the workstation 507 displays the search results 534. The displayed results reflect those stored in the database 513.

Referring to FIG. 5B, is a data flowchart depicting the serverless peer-to-peer 501 embodiment of the invention. A user workstation 507 remains as the user interface with the invention. In a presently preferred embodiment of the invention the invention resides as a software “plug-in” for a browser such as Internet Explorer® or Netscape®. As the user invokes a search engine with a search query, the inventive software stores the search query and formulates a formatted request 537. In a presently preferred embodiment the formatted request 537 includes many of the same elements as are present in the formatted request 516 (FIG. 5A) such as the role-bit flag 522, the RoleID 525, and the SearchQuery 528. Additionally, the presently preferred embodiment includes a BroadcastPeerID 543 that serves to identify the user as the ClientID 519 (FIG. 5A) does in the hierarchical embodiment as well as a BuddyListID 547. To some extent, the BuddyList ID may be redundant with the BroadcastPeerID 543 and practicing the invention with some sort of concatenated ID would also serve.

The formatted request 537 is broadcast over the Internet to interrogate peer workstations 508a, 508b for the presence of same or similar requests in databases resident in the inventive software. Each peer workstation 508a, 508b that has such a similar search query on file responds with a formatted response 540. The formatted response 540 indicates the BroadcastPeerID 543 to aid in routing the request and the URLInfoObjects 534 the peer workstation 508a, 508b finds associated with the search query in the software database.

Referring to FIG. 5C, is a data flowchart depicting the server-steered peer-to-peer 502 embodiment of the invention. As in the serverless peer-to-peer 502 embodiment, the user initiates the inventive process with a search of the Internet. The inventive software then formulates a formatted request 537. In a presently preferred embodiment the formatted request 537 includes many of the same elements as are present in the formatted request 516 (FIG. 5A) such as the role-bit flag 522, the RoleID 525, and the SearchQuery 528. Additionally, the presently preferred embodiment includes a BroadcastPeerID 543 that serves to identify the user as the ClientID 519 (FIG. 5A) does in the hierarchical embodiment as well as a BuddyListID 547. Rather than sending the formatted request directly to peers, the user workstation 507 transmits the formatted request 537 to a steering server 510. Advantageously, the steering server 510 may be the repository of the BuddyList database 405 (FIG. 4). In the steering server 510, the inventive software selects peer workstations 508a, 508b for transmitting the request according to associations with the user contained in the BuddyList database and optionally according to the roles selected by the user and contained in the formatted request 537. By directing or steering the formatted request, the social network is employed to enhance the filtering or ordering of results from a search engine. Advantageously, by using the steered server embodiment, the inventive method may be promulgated from a user-subscription service provider.

Once the selected peer workstations 508a and 508b receive the formatted requests, they respond identically to the peer workstations 508a and 508b in the serverless peer-to-peer embodiment (FIG. 5B), by referring to databases resident in the software contained in the peer workstation 508a and 508b. The formatted request 537 is broadcast over the Internet to interrogate peer workstations 508a, 508b for the presence of same or similar requests in databases resident in the inventive software. Each peer workstation 508a, 508b that has such a similar search query on file responds with a formatted response 540. The formatted response 540 indicates the BroadcastPeerID 543 to aid in routing the request and the URLInfoObjects 534 the peer workstation 508a, 508b finds associated with the search query in the software database.

Referring to FIG. 5D, is a data flowchart depicting the extended server-steered peer-to-peer 503 embodiment of the invention. As in the serverless peer-to-peer 502 embodiment, the user initiates the inventive process with a search of the Internet. The inventive software then formulates a formatted request 537. The user workstation 507 transmits the formatted request 537 to a steering server 510. In the steering server 510, the inventive software selects peer workstations 508a, 508b, 508c for transmitting the request according to associations with the user contained in the BuddyList database and optionally according to the roles selected by the user and contained in the formatted request 537. In addition to the transmission to the several peer workstations 508a, 508b, 508c, the server 510 sends the formatted request to node servers 546 in a SearchBuddy™ network. Each of the node servers 546 further steer the formatted request 549 to remote peer workstations 508p, 508q. By directing or steering the formatted request to selected peer workstations 508a, 508b, 508c, 508p, 508q, the social network is employed to enhance the filtering or ordering of results from a search engine.

Once the selected peer workstations 508a, 508b, 508c, 508p, 508q receive the formatted requests, they respond identically to the peer workstations 508a and 508b in the serverless peer-to-peer embodiment (FIG. 5B), by referring to databases resident in the software contained in the peer workstation 508a, 508b, 508c, 508p, 508q. The formatted request 537 is broadcast over the Internet to interrogate peer workstations 508a, 508b, 508c, 508p, 508q for the presence of same or similar requests in databases resident in the inventive software. Each peer workstation 508a, 508b, 508c, 508p, 508q that has such a similar search query on file responds with a formatted response 540.

When the user workstation 507 receives the formatted responses 540 from the various peer workstations 508a, 508b, 508c, 508p, 508q or from the server 510 the inventive software resident thereon will compile the received formatted responses 540 to display them at the user workstation 507. In a presently preferred embodiment, the results are compiled into HTML content to report the results.

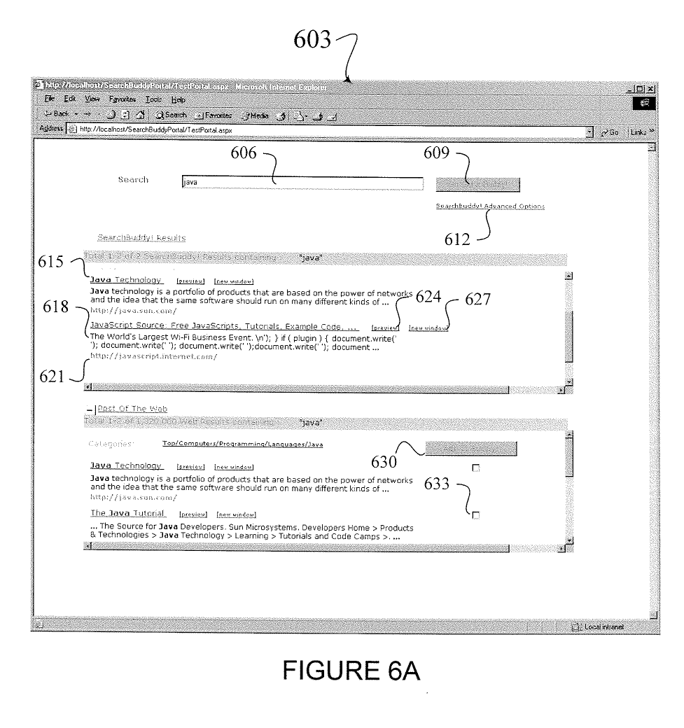

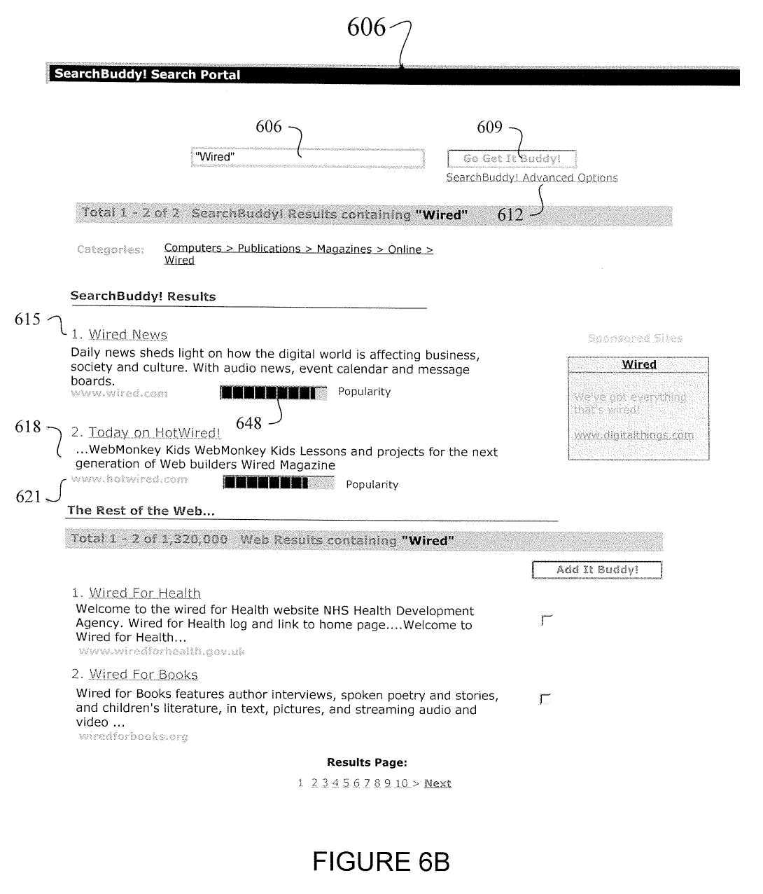

Referring to FIG. 6A, one presently preferred embodiment of the reporting page 603 is depicted. Many features are selected to imitate the reporting format that has become common among various search engines in order to enhance the intuitive nature of the report page 603. A search-refining pane 606 is provided to allow interaction with the search engine in response to the reported results. To execute the search set forth in the refining pane 606, the user activates an execute button 609, in this case optionally labeled “Go get it, Buddy.” Advanced searching options are available in a manner similar to those known in the art, are provided a hot link 612 to a formatting page that enables an automate formulation of Boolean search requests.

The results of the search are displayed in a squib format with a single squib reporting out a page located at a URL address. Each squib has several elements. A first hot button 615 linking to the page at the URL bears the title of the page. A second hot button 621 also linking to the page at the URL bears the URL address. Between the first hot button 615 and the second hot button 621, a short excerpted paragraph or partial paragraph that contains the content found on the page in close proximity to the words comprised in the search query that generated the results. A third hot button 624 allows a preview of the text contained at the site, while a fourth hot button 627 allows review of the site in a new window. While each of the features described herein harmonize the reporting page with those used for common search engines no one or combination of them are necessary for the practice of the invention and are provided only to enhance the dialogue between the user and the inventive software.

An object of the invention is to leverage the search experience of the numerous users to appropriately rate the utility of sites in response to search queries. To facilitate that leveraging process, the software receives feedback from the user in either an active or a passive mode. While the passive mode is accomplished by any of several means including tracking the user's use of the content found at any of the pages (for instance the numbers of uses of links contained at the site or time spent at the site). Alternatively, the active system allows an individual the opportunity to opt a site into the SearchBuddy database by activating check boxes 633 corresponding to relevant sites and then activating an execution button 630 labeled “Add it, Buddy.”

Optionally, as a BuddyList grows and the inventive database is populated with the results of more active searches, an alternate report page 606 will additionally rate sites reported as results are more frequently reported to common searches. As with the reporting page 603 (FIG. 6A), a search-refining pane 606 and an execute button 609, in this case optionally labeled “Go get it, Buddy” are provided along with an advanced searching options hot link 612.

Each squib is enhance with a normalized graphic scale 648 indicating popularity of the reported site. The hot buttons 615 and 621 remain as well as a short excerpted paragraph or partial paragraph that contains the content found on the page in close proximity to the words comprised in the search query that generated the results. Again, while each of the features described herein harmonize the reporting page with those used for common search engines no one or combination of them are necessary for the practice of the invention and are provided only to enhance the dialogue between the user and the inventive software.

As set forth above, a PotentialUser object 432 (FIG. 4) may well be contained in a “phonebook” or other email directory maintained by the user and containing email addresses. Alternatively, the user may create the PotentialUser object 432 on an “as needed” basis. A RecommendationID object 435 is created to associate the PotentialUser 435 object with the content at the URL and the UserID.

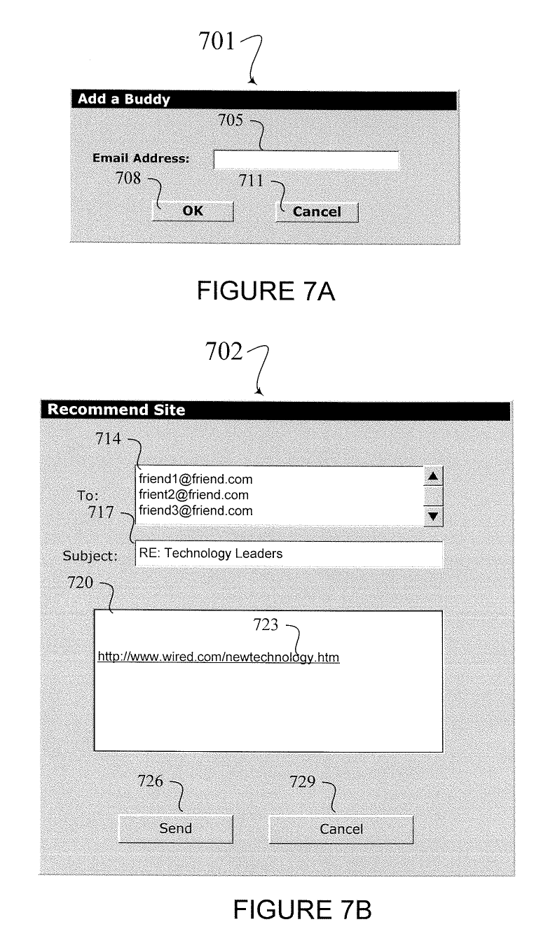

Referring to FIG. 7A, a dialogue box 701 for creating PotentialUser objects 432 (FIG. 4). The inventive software generates the dialogue box 701 to assist the user in augmenting a SearchBuddy database. The dialogue box 701 provides a pane 705 allowing the user to provide an email address to direct a request to enable the inventive software on the email recipient's workstation. As is customary, the dialogue box 701 provides an execute button 708 labeled “OK” and a cancel button 711 labeled “Cancel” affording the choice to the user to execute the action or to cancel it. The dialogue box 701 persists until the user selects either to execute or to cancel the action.

Referring to FIG. 7B, a dialogue box 702 for executing the recommendation process is depicted. The dialogue box 702 will serve to allow recommendation of a website to a potential user at an email address. A pane 714 is provided to the user to allow the listing of one or multiple email addresses. Once the user completes the list of email addresses in the pane 714, the user may assign a subject in a pane 717 to the recommendation. Optionally, where the user provides no subject, the subject line will be filled in with an assigned title of the content found at a recommended URL address 723. In a pane 720, the user may provided desired text of an email message recommending the site. By default the URL 723 is provided in the text of the message. Optionally, the URL 723 may be suppressed in the display of the pane 720. Again, the dialogue box 702 provides an execute button 726 labeled “Send” and a cancel button 729 labeled “Cancel” affording the choice to the user to execute the action or to cancel it. The dialogue box 702 persists until the user selects either to execute or to cancel the action.

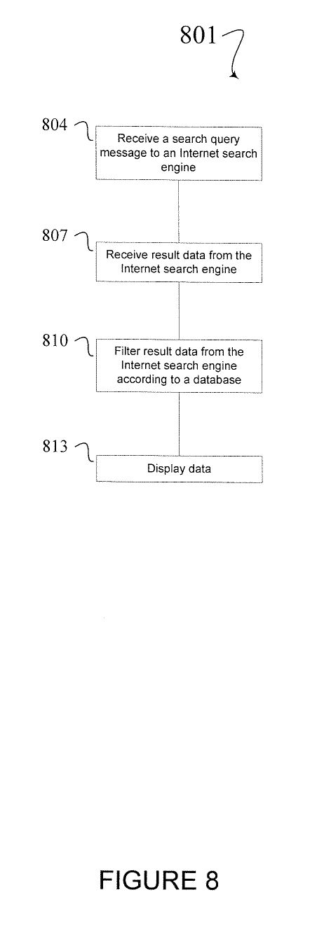

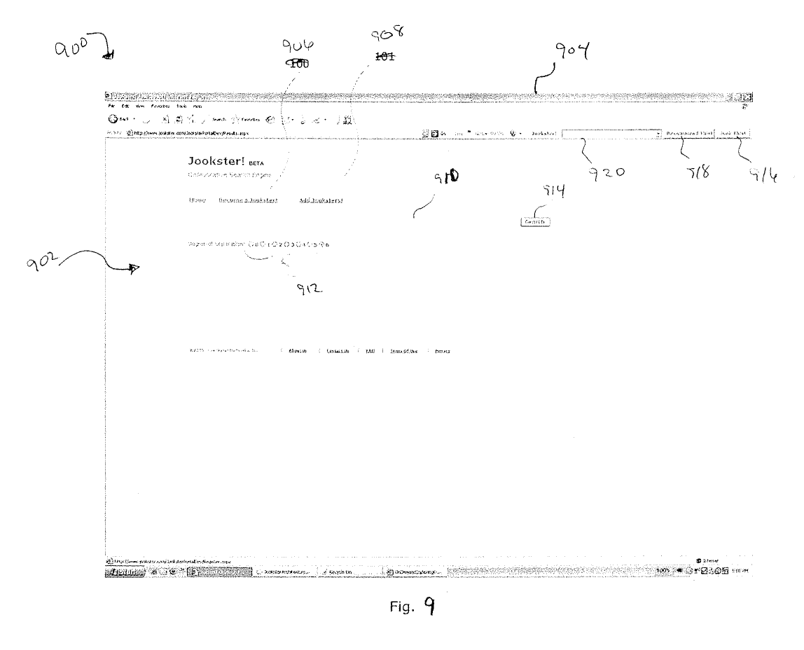

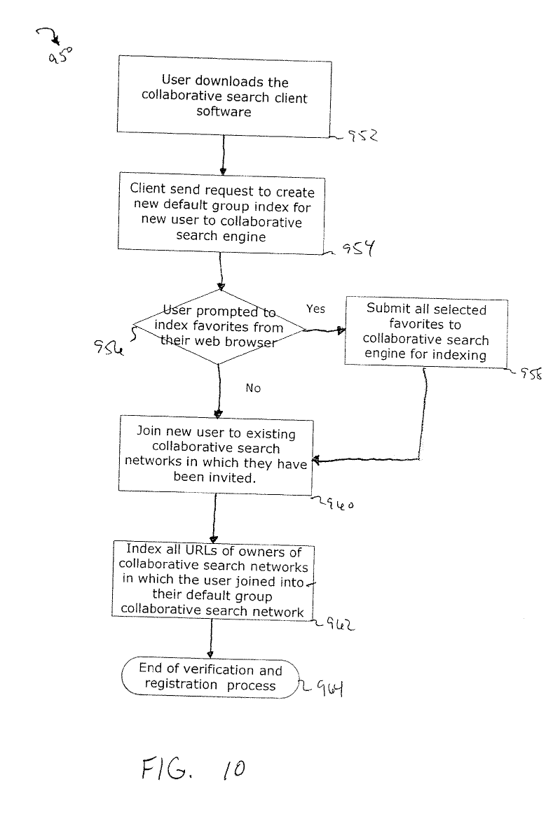

Referring to FIG. 8, a flowchart 801 depicts a method for filtering results of a search of the Internet. At a block 804, filtering Internet content includes receiving a search query message comprising a search query to an Internet search engine.

At a block 807, data is received from the Internet search engine, responsive to the search query message.

At a block 810, filtering of the data produces a data subset. The filter selects data for inclusion in the data subset based upon occurrence of the data in a database. The database includes content selected for inclusion by designated users. As indicated in the discussion above, the database includes the result of several searches by the designated users.

At a block 813, the data subset is displayed in a browser.

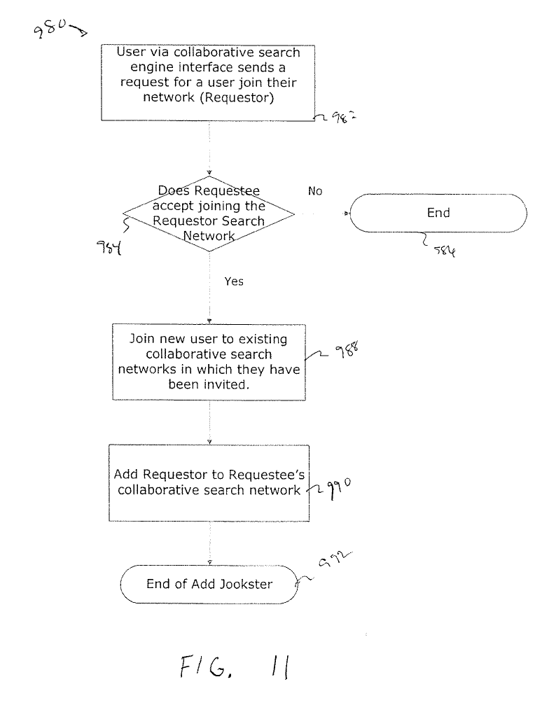

FIGS. 9 through 16 illustrate additional embodiments of the invention in which a collaborative search engine dynamically indexes data or metadata associated with electronic resources, such as are accessible via the World Wide Web, based upon the actions of users identifying either directly or indirectly the content of the electronic resources as being of interest. The electronic resources may be web pages, video files, audio files, image files, streaming media content, or any other content available over an electronic network such as the Internet. The electronic resources are also referred to as being information, and references to information should also be understood to refer to being an electronic resource when stated in the proper context, such as a first user viewing information and indicating it to be of interest. The information being viewed could be any electronic resource. The electronic resources may be identified using a Uniform Resource Locator (URL), that is also referred to as an address in the descriptions for some of the FIGURES.

Unlike traditional search engines that automatically, through the process of crawling, index the whole internet, the collaborative search engine is explicitly notified through information provided by user interaction what content to index. The collaborative search engine also defines a format and architecture in which information is indexed or catalogued into groups based upon the association of users with each other and the proximity of users to each other within an electronic social network. This allows particular users and their associated electronic social networks of other users to define and filter which resources are indexed and searched. Indexing the resources may include building an indexed database by storing addresses of the resources in association with identities that are stored for each user. Indexing may also include parsing the resources to obtain keywords and metadata associated with the resources that are then stored in the indexed database.

FIG. 9 is a diagram depicting an example user interface 900 in accordance with an embodiment of the invention. The user interface 900 includes a plurality of selectable options that are available when a particular web page 902 is open in a browser 904 window as well as options that are available at any time the browser 904 is open. A joining option 906 appears as a clickable link on the web page 902. In this example, the joining option 906 is indicated by the words “Become a Jookster!”, but other words or symbols may be used in other embodiments. A user may elect to activate the joining option 906, in order to establish an identity to be stored in a databse. Upon user activation of the joining option 906, a user enters optional registration information stored in the database in association with an identifier.

Additionally, upon activation of the joining option 906, the user initiates the formation of a social network by designating at least one second user to be associated with the identity. After a user has joined and stored the association to at least one second user, the user may augment the stored social network by, in at least one embodiment, activating an add members option 908. In this non-limiting example, the add members option 908 is indicated by the words “Add Jooksters!”, but other words or symbols may be used in other embodiments.

The in a non-limiting exemple of the interface 900, a web page 902 includes resources to be displayed; a resource may be all or a subset of the information displayed in a webpage. The interface also includes a search window 910 configured to allow a user to enter key words to initiate a search from among resources that have been suitably stored and indexed in the database in a manner as described below; the resources appended to the database because one or more users whose identity is stored in the database have found the resources to be interesting.

A degree of separation indicator 912 is also present on the web page 902. The degree of separation indicator 912, receives the user selection of a radius. The radius defines the number of links from the user, as defined in the social network stored in the database that the user wishes to have traversed by a search process. The first link refers to searching all of the resources indicated as interesting by the second users; the second users being those that the first user has elected to store in association with the first user's identity in the database. To traverse a second link means to also search the resources indicated as interesting by each of the users that the second users have elected to store in association with each of the second users' identities within the database. In a similar fashion, a radius may be designated that encompasses the entirety of the users stored within the database.

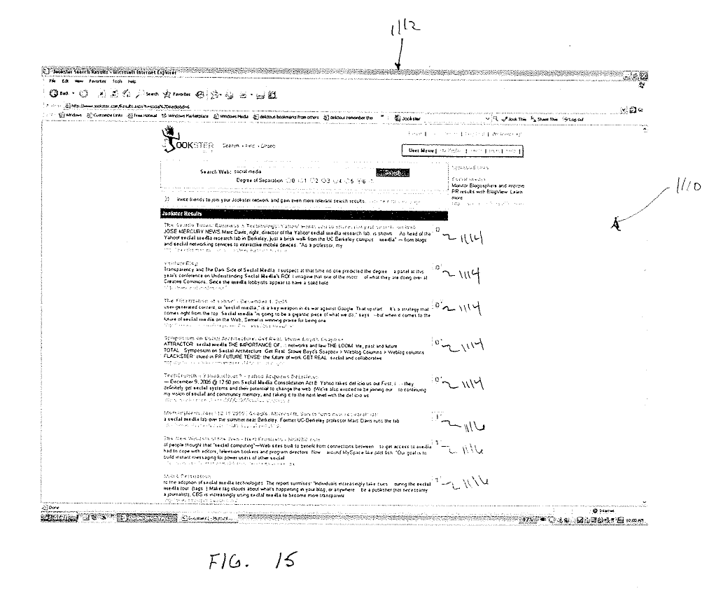

By way of non-limiting example, the degree of separation indicator 912 includes degrees of separation from 0 to 6. For purposes of the example, 6 is selected to indicate a radius that encompasses the whole of the database, though the radius necessary to encompass such a database is readily calculated dynamically based upon the user's selected second user's and their selections in turn. A degree of 0 indicates that the user wishes to have only resources that they have personally indicated as being interesting to be searched. Higher degrees of separation indicate increasing separation from the user in their electronically stored social network. This is explained in greater detail with reference to FIG. 14.

After key words have been entered in the search window 910 and the degree of separation has been selected by means of the degree of separation indicator 912, a search button 914 is clicked by the user to begin a search process. The search process is based on the entered key words and searches within a subset of the resources stored in the database and implicated according to radius entered in the degree of separation indicator 912.

In one embodiment, the user interface 900 includes a series of buttons indicative of user options that remain present even when the web page 902 is no longer present in the browser 904 window. These buttons include an indication of interest button 916, a recommendation button 918, and a toolbar search window 920. In this non-limiting example, the indication of interest button 916 is indicated by the words “Jook This!”, but other words or symbols may be used in other embodiments. If the user is viewing a web page or other resource in the browser 904 window, the user simply clicks or otherwise activates the indication of interest button 916 thereby to send information to the server on which the database is resident indicating that the user found the currently viewed resource to be of interest. When a user activates the indication of interest button 916 the sent information causes the database to associate the resource with the user's identity, if it has not already done so, and if it has done so. In this non-limiting example, the recommendation button 918 is indicated by the words “Recommend This!”, but other words or symbols may be used in other embodiments.

In some embodiments, while the user is viewing a web page or other electronic resource in the browser 904 window, the user simply clicks the recommendation button 918 to begin a process of sending a link or other information related to the resource to another person, thereby recommending the resource. In at least one embodiment, to click the recommendation button 918 also includes parsing the resource if it has not already done so, to generate a set of keywords to be stored in association with an identity of the resource. In the at least one embodiment, sending the recommendation to another user, the database recognizes that the user finds the site interesting, thus sending a signal or notification to the server on which the database resides that the user found the information to be of interest. In embodiments where parsing of resources occurs according to the method disclosed with reference to FIG. 14, the resource is indexed and cataloged.

In some embodiments, sending a recommendation to an email address for whom no identity is stored in the database and causes a similar signal to be transmitted indicating the information is of interest. To facilitate the action, a provisional identity associated with the email address and designating the user as a second user relative to the provisional identity. In at least one such embodiment, the server sends an invitation to the email address, allowing the recipient to join. If the recipient elects to join, actions that may optionally include downloading software from the server, will include removing the provisional status from the associated provisional identity, thereby establishing a new account.

In some embodiments, a toolbar search window 920 facilitates a search according to the method described above for use of the search window 910. The toolbar search window 920 obviate's the user's need to use the web page 902. In one such embodiment, a degree of separation indicator is not specified in conjunction with using the toolbar search window 920. Rather, when the toolbar search window 920 is used, a default radius is assigned according to designations stored in the database in association with the user. In some embodiments, the default radius is a radius selected to encompass the whole of the database. In this non-limiting example, a radius of 6 degrees is selected, resulting in a search of all electronic resources indicated as interesting by any user. However, in other embodiments, the default degree of separation indicator is set differently. The default degree of separation indicator may be set to the one last set by the user via the degree of separation indicator 912, for example. Alternatively, other embodiments include a toolbar degree of separation indicator similar to the degree of separation indicator 912 within the toolbar as well so a radius may be specified.

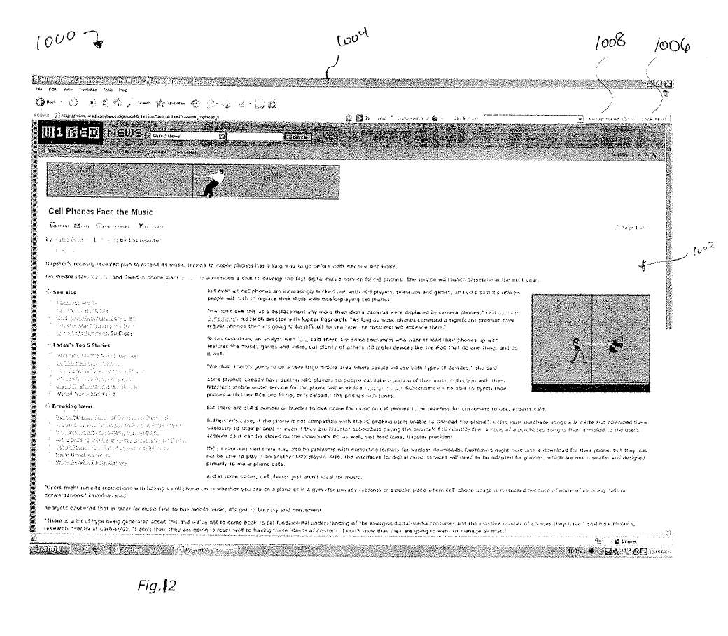

FIG. 10 is a flowchart depicting a non-limiting examplary process 950. The process 950 is one of indexing electronic resources in accordance with an embodiment of the invention. First, at a block 952, a new user downloads collaborative search client software. In an embodiment, the new user initiates the download and installation of the client software by clicking a joining option button 906 shown in FIG. 9, for example.

Next, at a block 954, the installed client software sends a request that a group index be created for the new user initiating the user's stored social network.

Optionally, at a decision block 956, the user is prompted to indicate whether the user wishes to index a number of favorites or bookmarks the user has stored on a user's client computer in accord with web browsing software the user has previously installed. If the user indicates a ‘yes’ response, the client software uploads the user's favorites or bookmarks are onto the server for storing the favorites or bookmarks as though the user had designated at a block 958.

If the user indicates a ‘no’ response at the decision block 956, a block 960 follows where the user indicates identities of second users to associate with the user's identity. In some instances, by accepting the invitations before downloading the collaborative search client software at the block 952, some such second users have already been indicated by operation of the client software. The block 960 also follows the submission of favorites or bookmarks performed at the block 958. Next, at a block 962, URLs of owners of collaborative search networks in which the user joined in the block 960 are parsed and added to the user's default group collaborative search network. The process then ends at a block 964.

FIG. 11 is a flowchart depicting a non-limiting examplary process 980 adding a user to the database in accordance with an embodiment.

At a block 982, a first user sends a request for a second user to join the first user's social network using a collaborative search engine interface. In a number of embodiments, such a request will be transmitted to the second user by the known means of email. In one embodiment, the client software will compose an email message with sufficient indicia embedded within the headers and text of the email to indicate to the server the purpose of the email and to suitably identify both of the first and the second users for the server to store an association between the first and the second users in the database. In an alternate embodiment, te information is generated by the client software and sent be network means directly to the client software for generation of the association within the database.

At a decision block 984, it is determined whether the second user accepts the request. As with the request itself, in some embodiments, the use of email is a possible conduit for the information indicative of the second user's acceptance. Otherwise, the second user may choose to download and install the client software along with a key number generated and sent in the invitation email. By such means as are included in the respective embodiments, the second user establishes an account on the database and the association with the first user, if the second user accepts the invitation. If, on the other hand, the answer is no, the process ends at a block 986. If the answer is yes, the second user is joined to the first user's existing collaborative search network at a block 988. Then, at a block 990, the first user is added to the second user's collaborative search network. The process then ends at a block 992.

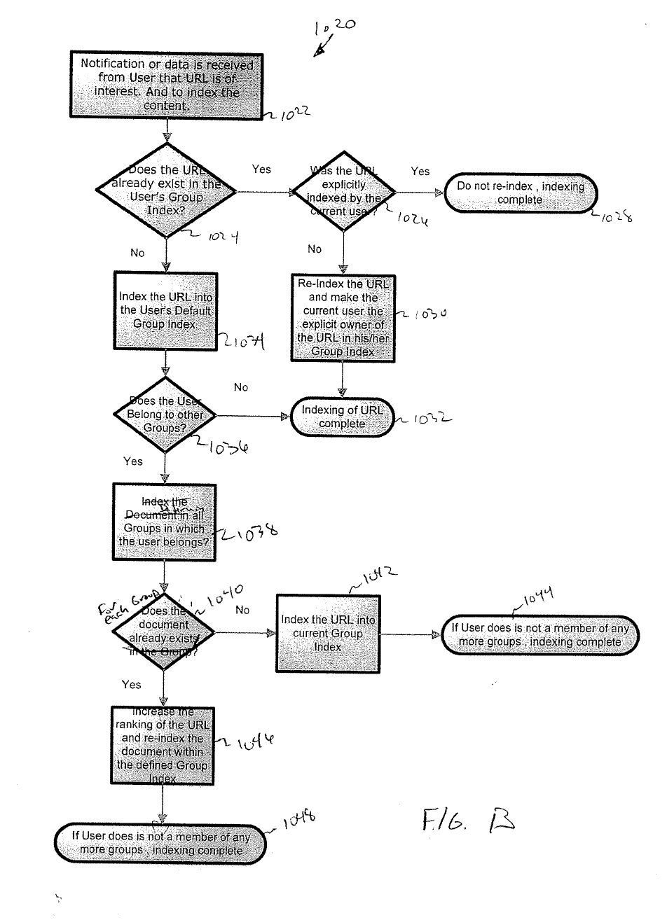

FIG. 12 is a diagram depicting a non-limiting examplary user interface 1000 used to indicate a resource that is of interest in accordance with an embodiment of the invention. In this non-limiting example of a first embodiment, the resource is displayed as a web page 1002 which appears in a window of a browser 1004. The web page 1002 a user may choose to indicate that the resource is of of interest to the user of the browser 1004 by clicking an indication of interest button 1006 that serves the same function as the indication of interest button 916 described in reference to FIG. 9. The user may also recommend the web page 1002 to another user using a recommendation button 1008 that serves the same function as the recommendation button 918 described in reference to FIG. 9.

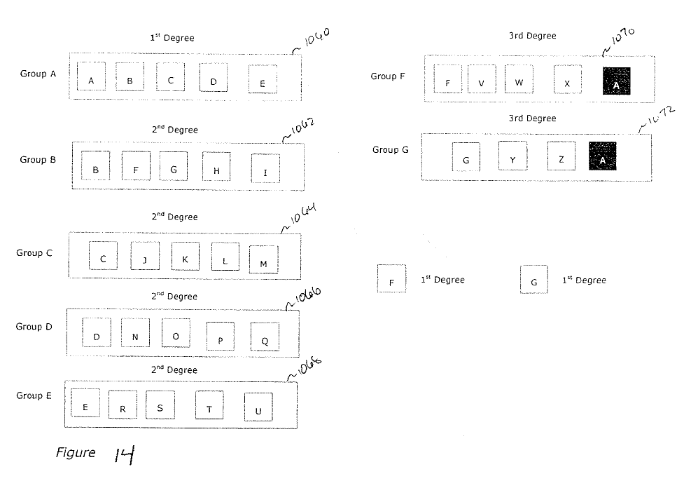

FIG. 13 is a flowchart depicting a non-limiting examplary process 1020 of parsing a resource in accordance with an embodiment of the invention. While not the exclusive means for allowing generation of group associations, this examplye demonstrates at least one means for storing associations in the database. Storage of group associations allows for rapid searching of the database in response to the a user's later search requests.

First, at a block 1022, a signal, notification, or data is received from a first user that a resource stored at a given Uniform Resource Locator (“URL”) is of interest to the first user. The signal is advantageously generated, by way of non-limiting example secondary to a user clicking on the indication of interest button 1006, for example.

At a decision block 1024, it is determined whether the resource as indicated by the URL already exists in the first user's group index. If the answer is yes, a second decision block 1026 follows, where it is determined whether the URL was previously explicitly indicated as being of interest by the first user. If the answer is yes, the process ends at a block 1028. If the URL was not previously explicitly indicated as being of interest by the first user, the URL is re-indexed or parsed and the resulting keywords are associated with the first user in the database. The process then is complete at a block 1032. If, at the block 1024, the URL was found to not already exist in the first user's group index, a block 1034 follows, where the URL is indexed or parsed into the first user's index.

At a decision block 1036, it is determined whether the first user belongs to other groups. If the answer is no, the process ends at the block 1032. If the answer is yes, a block 1038 follows where all groups in which the first user belongs are determined. Then, a decision block 1040 follows, where for each group in which the first user belongs, it is determined whether the URL is associated with each group associated with the first user. If the answer is no, a block 1042 follows where the URL is indexed or parsed into the current group index. Then, at a block 1044, if the first user is not a member of any more groups, the indexing is complete. If the answer is yes at the decision block 1040, a block 1046 follows, where the ranking of the URL is increased and the URL is re-indexed within the group index. Then, at a block 1048, if the first user is not a member of any more groups, the indexing is complete.

FIG. 14 is a diagram depicting a non-limiting examplarly indexing architecture for ordering resources in the database in accordance with an embodiment of the invention. A series of users are identified by letters A through Z. For the purposes of the non-limiting example, groups exist according to one or another first user definition. Such examples might include “sailor,” “dentist,” “sudoku puzzle solvers” or any other themed group. A first user might define and therefore own any number of groups. Each user associated with such a group provides bridges to other groups as a function of multiple group membership. Thus, a degree of separation designation having a radius of two would include not only the first group of which the first user is a member, but all groups which also include any member of the first group.

Group boxes for users A through G are shown as boxes 1060, 1062, 1064, 1066, 1068, 1070, and 1072, respectively. For purposes of this example, group boxes for users H through Z only include the owner of the group box to allow a clear exposition of operation. In practice, however, a group will generally include an association to at least one second user for each group as designated by the first user. The individual boxes in each group box 1060 to 1072 indicate the owner of the group as well as any users added to the group by the owner. For example, user A's group box 1060 includes the owner (user A) as well as users B, C, D, and E that user A added to user A's group. When referring to themselves, the group owner is considered to be at zero degrees of separation, or a radius of zero. Any users in a group owner's box are considered to be at one degree or separation, or a radius of one. For example, for user A, users B, C, D, and E are at a radius of one.

Additionally, users F and G are at one degree of separation from user A, even though they are not shown in user A's group box 1060. Because degree of separation is not defined with reference to a single group, users F and G are associated with A because user A appears in the group boxes 1070, 1072 of the users F and G. In the non-limiting exemplary embodiment, such associations are reciprocal and the fact that user A is in the group boxes 1070, 1072 of users F and G causes users F and G to be at one degree of separation from user A simply because user A is at one degree of separation from each of users F and G.

In other embodiments, however, such associations may not be reciprocal. In one such embodiment, users H and I are considered to be at two degrees of separation from the user A. The designation of two degrees of separation is generated on a path from user A such that user B appears in user A's group box 1060 and users H and I appear in user B's group box 1062. Users H and I only have themselves in their respective group boxes, in contrast to users F and G, which both have user A in their group boxes 1070 and 1072. Although it may appear that users F and G are at two degrees of separation or a radius of two from user A, in similar fashion to users H and I, this is not the case because in this embodiment the least degree of separation possible will be assigned. As explained above, this is a first degree of separation, or a radius of one for users F and G with respect to user A. A third degree of separation can be imagined if the user A were to be removed from the user G's group box 1072. In that case, user G would be separated by two degrees or a radius of two from user A, in similar fashion to users H and I. Then, users Y and Z would be considered to be at three degrees of separation or a radius of three from user A based on the associations provided in this example. Thus, searches conducted by the user A specifying a radius of two or less would not retrieve results that had been marked interesting by only users Y and Z. However, a search specifying a radius of three or more would retrieve results marked as interesting by only users Y and Z.

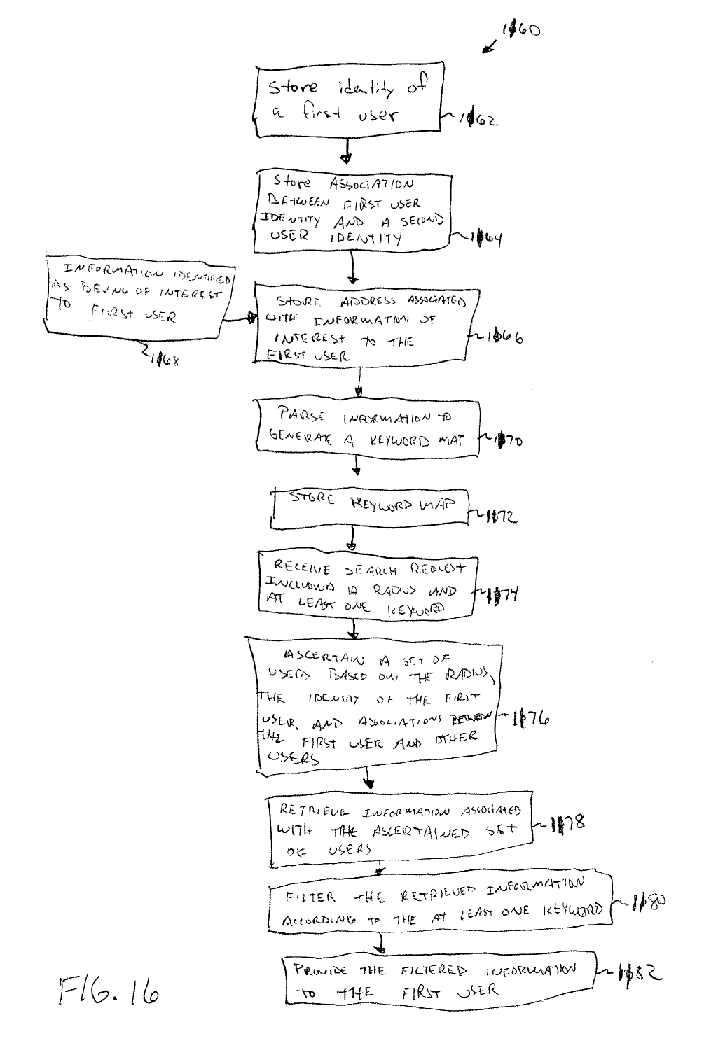

FIG. 15 is a diagram depicting a non-limiting example of a search results in a format in accord with an embodiment of the invention. Results of a search are used by the database to generate a web page 1110 that in turn is displayed in a browser 1112 window. As is depicted in FIG. 15, the exemplary web page was generated for search results based on the keywords ‘social media’.

According to a user designation stored in the database, brief excerpts of each result are presented, along with a title and URL for each, though such a format is not the sole means by which results might be displayed in a web page. In addition, to the right of each excerpt, a degree of separation indicator 1114, 1116 appears. In this non-limiting example, the degree of separation indicator 1114 indicates a degree of separation of zero degrees from the user that conducted the search. As mentioned in relation to other Figures, the degree of separation indicator is also referred to as a radius, such that in this case a degree of separation of zero degrees is equivalent to a radius of zero. The degree of separation indicator 1116 indicates a degree of separation of one degree, or other users that directly associated with the user conducting the search, rather than only being connected by one or more additional users. The ordering of the search results on the web page 1110 within each degree of separation may be in order of ranking from highest to lowest, for example, based on a ranking indicator that is updated as described in the block 1046 of FIG. 13, for example.

FIG. 16 is a flowchart depicting an example process 1160 of building an indexed database in accordance with an embodiment of the invention. At a block 1162, an identity of a first user is stored on a server. This identity may be stored in response to the first user joining a collaborative search network using the joining option 906 described in reference to FIG. 9, for example. In other embodiments, the identity may be imported from an existing database, or alternatively may be translated into an identity derived from an existing database. Next, at a block 1164, an association between the identity of the first user an identity of a second user is stored on the server. The association may be stored in response to the process described in FIG. 11 for adding a user to an existing network, for example. Alternatively, in another embodiment, the association may be imported from an existing database, or alternatively may be derived from associations in an existing database. The existing database may be located on a network as a previously existing social network, or may be located on the first user's computer as contact information, for example. Then, at a block 1166, an address is stored in association with the identity of the first user, the address being associated with information of interest to the first user. The information may have been previously identified by the first user as being of interest at a block 1168 when the first user viewed the information that was stored on a first network, for example. Identification of the information as being of interest would have then caused a signal, notification, or data to be sent from the first user that would then be received by the server so that the signal indicating the information is of interest could be acted upon in the process 1160. Then, at a block 1170, the information is parsed to generate a keyword map. The parsing at the block 1170 may also parse metadata associated with the information of interest. Additionally, the parsing may include the extraction of titles and other information in addition to the generation of a keyword map. Next, at a block 1172, the keyword map and other information obtained by the parsing process is stored. In some embodiments, the steps performed at the blocks 1166, 1170, and 1172 may be performed by an indexing robot such as are used to crawl and index the world wide web on the internet.

At a block 1174, a search request is received from the first user that includes at least one keyword and a radius, where the radius corresponds to the degree of separation identifier 912 discussed in relation to FIG. 9, for example. At a block 1176, a set of users is ascertained based upon the radius, the identity of the first user, and associations between the first user and other users. The set of users is selected according to a number of spanned associations corresponding to the radius from the first user. At a block 1178, information is retrieved that is stored in association with each user in the set of users. Next, at a block 1180, the retrieved information is filtered according to the at least one keyword. In other embodiments, the actions performed in the blocks 1178 and 1180 may be performed in reverse order, or simultaneously. Then, at a block 1182, the information is provided to the first user.

In some embodiments, the information is provided with a radius corresponding to each result so the first user will know how many associations in the collaborative search network were spanned in finding each result. Other embodiments include a ranking identifier as a part of the provided results. Still other embodiments use a ranking identifier implicitly by providing higher ranked results within a particular radius grouping before lower ranked results within the same grouping, but without providing the ranking identifier itself. The resulting ranking of results may then be displayed by the first user's client computer as shown in FIG. 15, for example.

At the block 1168, the first user may have indicated information was of interest using any of a variety of methods. In embodiments, the indication of interest is accomplished through performance of a single action such as clicking on a generated button indication. Alternatively, generation of a signal is based upon the presence of a URL designating a resource within bookmark or favorites data stored on the first user's client computer. Alternatively, the client software generates the signal based upon the first user recommending information to a second user by means of a third electronic network. The third network that may be the same as, or encompass a subset of either the first or the second networks. Alternatively, the signal is generated based upon positioning a cursor over a predefined area of the displayed information or indication, by producing a sound, by selecting using a remote control device such as a television remote control, by depressing a key on a key pad, by selecting using a pointing device, or by the selection of a displayed indication such as by clicking a button displayed on a user interface or checking a box displayed on a user interface.

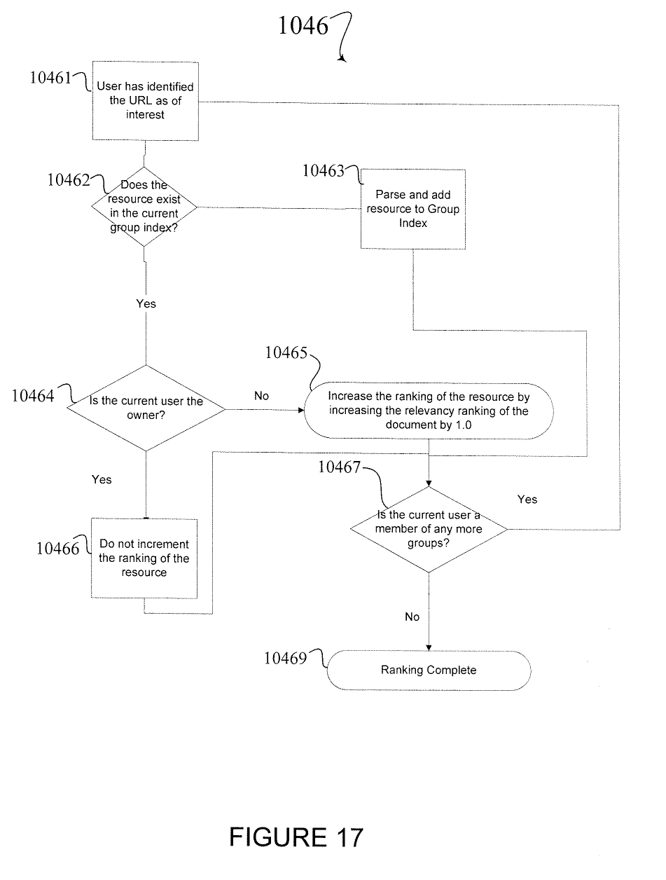

Referring to FIG. 17, a method 1046 for ranking of the URLs is presented as an optional amplification of the method described at the block 1046 with reference to the method discussed with reference to FIG. 13. The method 1046 includes actions to increase rankings according to interest of persons within the group and the URL is re-indexed within a group index for all members of the group. The purpose of the ranking is to gain and appropriately benefit from the experience of the group of users thereby assuring that if multiple users find a particular resource of be of assistance, that resource will be appropriately promoted in the ranked reported results.

At a block 10461, a user has identified a resource of interest by the above-described means. As described above, a signal is generated and conveyed to the server upon which the database resides at the box 10461 and the signal indicates the resource of interest as well as the user.

At a decision block 10462, the resource is examined to determine if the resource has been previously identified in association with the group index. At the block 10462, not only is the resource examined as existing in the group index but the current version of information stored at the URL is compared with any earlier versions stored in order to update the relevance of the group index, thereby assuring that only the most recent iterations of resources will steer searches relying upon the group index.

If, at the block 10462, the server determines that the resource ought to be added to the group index, at a block 10463, the resource is parsed and suitably added to the group index. If not, the server, at a block 10463, will determine whether the current user is the owner of the resource within the group. In the terms of the FIG. 17, owners are any of the individuals that have indicated that the resource is of interest to them.

Determining owners for each of the several resources that make up the group index is important because it inherently limits the ability of a subgroup within the group to “stuff the ballot box” when the server determines the relevancy of the resource. Each owner is only allowed, by their determination of interest in the resource to increment the relevancy score by only one. Thus, if at the block 10463, the user is determined to be one of the owners of the resource within the group, the server, at the block 10464 does not increment the relevance and moves to block 10467.

If the user is not determined to be one of the owners, then at a block 10465, the relevancy score of the resource is incremented by one so that in searches now, the relevancy score weighs the average and moves the resource up in the resulting ranking as presented in response to a search that includes the resource.

At the block 10467, the server retrieves the user identity data to determine if the current group is the sole group to which the user currently subscribes. If it is not, from the 10467, the process is repeated for each of the other user groups to which the user belongs.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for building an indexed database comprising:
storing an identity of a first user on a server;
storing an association between the identity of the first user and an identity of a second user on the server; and
storing an address in association with the identity of the first user, the address associated with information of interest to the first user stored on a first network.

2. The method of claim 1, wherein the information of interest was previously identified by receiving at the server a signal from the first user indicating the information stored on the first network is of interest to the first user.

3. The method of claim 1, wherein storing an identity includes importing the identity from another database and storing an association includes importing the association from another database.

4. The method of claim 2, wherein receiving the signal includes receiving the signal at the server from a client computer in communication with the server over a second network.

5. The method of claim 4, wherein the second network is included in the first network.

6. The method of claim 4, wherein the client computer generates the signal based upon bookmark data stored on the client computer.

7. The method of claim 4, wherein the client computer generates the signal based upon the first user recommending the information to the second user using a third electronic network.

8. The method of claim 4, wherein the client computer includes a user interface configured to display the information, the user interface being further configured to generate the signal in response to only a single action being performed.

9. The method of claim 8, wherein the single action is clicking a mouse button when a cursor is positioned over a predefined area of the displayed information.

10. The method of claim 8, wherein the single action is a sound generated by the user.

11. The method of claim 8, wherein the single action is selection using a television remote control.

12. The method of claim 8, wherein the single action is depressing a key on a key pad.

13. The method of claim 8, wherein the single action is selecting using a pointing device.

14. The method of claim 8, wherein the single action is selection of a displayed indication.

15. The method of claim 2, further comprising:
parsing the information stored at the address according to the occurrence of keywords within the information to generate a keyword map; and
storing the keyword map in association with the address.

16. The method of claim 15, wherein the keyword map includes metadata.

17. The method of claim 4, wherein the at least one association with the second user is generated based upon contact information stored on the client computer.

18. The method of claim 2, further comprising:
receiving a search request from the first user, the search request including a radius and at least one keyword from the first user;
ascertaining a set of users based upon the radius, the users being selected according to a number of spanned associations corresponding to the radius; and
retrieving information stored in association with each user in the set of users.

19. The method of claim 18, further comprising:
filtering the retrieved information according to the at least one keyword.

20. The method of claim 2, further comprising:
receiving a search request from the first user, the search request including a radius and at least one keyword from the first user; and
retrieving information stored in association with the at least one keyword.

21. The method of claim 20, further comprising:
ascertaining a set of users based upon the radius, the users being selected according to a number of spanned associations corresponding to the radius; and
filtering the retrieved information according to the ascertained set of users.
